(19) United States
(12) Patent Application Publication
(10) Pub. No.: US 2025/0196186 A1
(43) Pub. Date: Jun. 19, 2025

(54) ACOUSTIC TRANSDUCER

(71) Applicant: Thales Australia Limited, Sydney Olympic Park (AU)

(72) Inventor: David Ronald Jones, Cherrybrook (AU)

(21) Appl. No.: 19/055,109

(22) Filed: Feb. 17, 2025

Related U.S. Application Data
(63) Continuation-in-part of application No. 18/324,873, filed on May 26, 2023, now Pat. No. 12,226,800.
Application No. 18/324,873 is a continuation of application No. 16/346,150, filed on Apr. 30, 2019, now Pat. No. 11,697,134.

(30) Foreign Application Priority Data
Oct. 31, 2016 (AU) 2016904446

(51) Int. Cl. B06B 1/06; G10K 11/00; H04R 1/28; H04R 1/40; H04R 1/44; H04R 17/00; H04R 31/00

(52) U.S. Cl. CPC B06B 1/0603; G10K 11/006; H04R 1/2834; H04R 1/403; H04R 1/44; H04R 17/00; H04R 31/003; B06B 2201/74

(57) ABSTRACT

An acoustic transducer (30) deployable in a sonobuoy application. The acoustic transducer (30) having a support structure (36) connecting a base plate (32) of an active assembly, comprising a base plate (32) and a piezoelectric body (34) supported by the base plate (32) to a passive vibrator (38) supported by the support structure (36). Such that bending vibration of the active assembly (32, 34) is mechanically coupled via the support structure (36) to drive bending vibration of the passive vibrator (38). Multiple acoustic transducers of this type can be used to form a transducer array for a sonobuoy.

### RELATED APPLICATION

This application is a continuation-in-part of U.S. patent application Ser. No. 18/324,873 filed 26 May 2023, which is a continuation of U.S. patent application Ser. No. 16/346,150 filed 30 Apr. 2019, which is a 371 national phase of International patent application no. PCT/AU2017/050970 filed 7 Sep. 2017, which is based on and claims the benefit of the filing and priority dates of Australian patent application no. 2016904446 filed 31 Oct. 2016, the content of which as filed is incorporated herein by reference in its entirety.

### FIELD OF THE INVENTION

The present invention is generally related to an acoustic transducer, of particular but by no means exclusive application as an underwater acoustic transducer. An application of the acoustic transducer is in a sonobuoy array.

### BACKGROUND TO THE INVENTION

Acoustic or sonar transducers are employed to conduct, for example, marine geophysical surveys; they may be used as acoustic signal transmitters in sonobuoys, as transmitters for communications buoys, or in towed arrays as active sources.

One type of such a transducer is referred to as a piezoelectric bender, because it employs piezoelectric elements, typically of a ceramic material, to generate vibration. In transducers of this kind, the piezoelectric ceramic is generally the most costly component, and may amount to about 80% of the parts cost; it also usually contributes significantly to the transducer's mass. Ideally it is therefore desirable to use the smallest possible quantity of ceramic in a design, though the volume of ceramic required to provide enough power handling capability imposes a lower limit to any such paring or trimming of the ceramic components.

FIGS. 1A and 1B show schematically the configuration of such a known acoustic transducer, in the form of a piezoelectric bender 10. FIG. 1A is a top view (with encapsulating waterproof overmoulding omitted for clarity), while FIG. 1B is a cross sectional view through the centre of bender 10. These figures, it should be noted, are not to scale. Bender 10 comprises two identical circular base plates 12, 14. Each base plate 12, 14 has attached thereto a respective ceramic piezoelectric body 16, 18, thereby forming a pair of active assemblies, each comprising a base plate and a piezoelectric body. Bender 10 also includes an annular support structure 20 to which base plates 12, 14 are attached, which flexes as base plates 12, 14 are driven to vibrate about their respective equilibrium positions. (Support structure 20 would not normally be visible in the view of FIG. 1A, but its inner periphery is shown in dashed line to aid understanding.) In this example these components are circular, but in other examples they may be elliptical or rectangular. All of these components are encapsulated in a waterproof overmoulding 22.

Base plates 12, 14 and support structure 20 define an internal cavity 24, which may be filled with air, some other gas, a liquid, or a liquid with compliant components. The piezoelectric body 16, 18 are driven electrically so that the active assemblies vibrate in phase and resonate at the same frequency.

U.S. Pat. No. 8,139,443 discloses an underwater sound projector system that includes an array of acoustic transducers of this general type.

### SUMMARY OF THE INVENTION

In a first broad aspect the invention provides an acoustic transducer, comprising:
a support structure;
an active assembly comprising a base plate supported by the support structure and a piezoelectric body supported by the base plate; and
a passive vibrator supported by the support structure and mechanically coupled via the support structure to the active assembly so that bending vibration of the active assembly drives the passive vibrator to also bend and thereby vibrate, and
wherein the passive vibrator is configured to vibrate at a predetermined resonant frequency.

In an embodiment the piezoelectric body is a piezoelectric ceramic body. In another embodiment, the piezoelectric body is a single crystal body.

In one embodiment the passive vibrator is configured by any one or more of shape, thickness and material composition to resonate at the predetermined resonant frequency, and wherein the predetermined frequency is different to the resonant frequency of the active assembly. In one example of such an embodiment the passive vibrator comprises a plate, of a thickness configured to vibrate at the predetermined frequency, and wherein the predetermined frequency is half the resonant frequency of the active assembly. In an alternative example of such an embodiment the passive vibrator comprises a plate, of a thickness configured to vibrate at the predetermined frequency, and wherein the predetermined frequency is a harmonic of the resonant frequency of the active assembly.

In some alternative embodiments the passive vibrator comprises has a flextesional transducer shape. For example, the passive vibrator comprises can have any one of a domed, frustoconical, cymbal, or polyhedral flextesional shape. In some embodiments the passive vibrator is configured by any one or more of the flextensional shape, thickness and material composition to resonate at the predetermined resonant frequency, and wherein the predetermined frequency is different to the resonant frequency of the active assembly.

Embodiments of the acoustic transducer may further comprise a flexible encapsulating covering over the active assembly. In some embodiments the flexible encapsulating covering does not extend over the passive vibrator.

In an embodiment the periphery of the acoustic transducer is circular. In other embodiments the periphery of the acoustic transducer is elliptical, rectangular or other polygonal shape.

In some embodiments a cavity defined by the active assembly, the vibrator and the support structure is filled with a fluid.

In some embodiments the support structure is integral with the base plate and/or the passive vibrator.

In another broad aspect, the invention provides a sonobuoy transducer array, comprising:
a plurality of acoustic transducers as described in any of the embodiments above;
wherein the plurality of acoustic transducers are connected together to move between a proximal packed configuration and a spaced apart deployed configuration.

In another broad aspect, the invention provides an acoustic transducer, comprising:
a support structure;
an active assembly comprising a base plate supported by the support structure and a piezoelectric body supported by (and typically bonded to) the base plate; and
a passive vibrator supported by the support structure and coupled via the support structure to the active assembly so that vibration of the active assembly drives the passive vibrator;
wherein the active assembly and the passive vibrator have the same resonant frequency.

The passive vibrator may be described as acting like a diaphragm. When the piezoelectric body is appropriately electrically driven, the active assembly and the passive vibrator radiate into the surrounding medium substantially equally.

In one embodiment, the piezoelectric body is a piezoelectric ceramic body. In another embodiment, the piezoelectric body is a single crystal body.

The base plate may be metallic. The passive vibrator may be metallic.

While the base plate and the passive vibrator may be of different (e.g. metallic) composition, in an embodiment, the base plate and the passive vibrator are of the same metallic composition, the passive vibrator differing in thickness from the base plate such that the active assembly and the passive vibrator have a common resonant frequency.

In an embodiment, the passive vibrator comprises a plate.

In one embodiment, the transducer is circular (that is, as seen in the view of, for example, FIG. 1A). In other embodiments, the transducer is elliptical or rectangular, and still other shapes are contemplated.

A cavity defined by the active assembly, the vibrator and the support structure may be filled with a fluid, whether liquid or gas.

The support structure may be integral with the base plate and/or the passive vibrator.

In yet another broad aspect, the invention provides a transducer array, comprising:
a plurality of acoustic transducers as claimed in any one of the preceding claims;
wherein the plurality of acoustic transducers are spaced apart to utilise mutual interaction and thereby increase performance.

In a third broad aspect, the invention provides a method of manufacturing an acoustic transducer, the method comprising:
coupling an active assembly comprising a base plate and a piezoelectric body supported by the base plate to a passive vibrator by a support structure, such that vibration of the active assembly drives the passive vibrator at a common resonant frequency.

In an embodiment, the piezoelectric body is a piezoelectric ceramic body.

In another embodiment, the base plate and the passive vibrator are of the same metallic composition, the passive vibrator differing in thickness from the base plate such that the active assembly and the passive vibrator have a common resonant frequency.

In one embodiment, the passive vibrator comprises a plate.

In certain embodiments, the transducer is circular, elliptical or rectangular.

In further embodiments, a cavity defined by the active assembly, the vibrator and the support structure is filled with a fluid.

In an embodiment, the support structure is integral with the base plate and/or the passive vibrator.

It should be noted that any of the various individual features of each of the above aspects of the invention, and any of the various individual features of the embodiments described herein including in the claims, can be combined as suitable and desired.

### BRIEF DESCRIPTION OF THE DRAWINGS

In order that the invention may be more clearly ascertained, embodiments will now be described, by way of example, with reference to the accompanying drawing, in which:

FIGS. 1A and 1B are schematic views of a piezoelectric bender according to the background art;

FIG. 2 is a schematic cross-sectional view of a piezoelectric bender according to an embodiment of the present invention;

FIG. 3 is a schematic cross-sectional view of the piezoelectric bender of FIG. 2 in use;

FIG. 4 is a plot of transmit sensitivity (dB) versus frequency, for both a background art bender and a bender according to the embodiment of FIG. 2;

FIG. 5 is a plot of efficiency (%) versus frequency (kHz), for both a background art bender and a bender according to the embodiment of FIG. 2; and

FIG. 6 is a plot of source level versus drive voltage, for both a background art bender and a bender according to the embodiment of FIG. 2.

FIG. 7 is a schematic cross-sectional view of an example of a partially encapsulated embodiment of the piezoelectric bender.

FIG. 8 is a schematic cross-sectional view of an example of another partially encapsulated embodiment of the piezoelectric bender.

FIG. 9 is schematic cross-sectional view of an alternative embodiment of a piezoelectric bender having a cymbal shaped passive vibrator.

FIG. 10 is a schematic cross-sectional view of an alternative embodiment of a piezoelectric bender having a curved or dome shaped passive vibrator.

FIG. 11 is a schematic cross-sectional view of the piezoelectric bender of FIG. 10 in use.

FIG. 12 is a representative example schematic of a sonobuoy embodiment employing embodiments of the described piezoelectric benders.

### DETAILED DESCRIPTION OF EMBODIMENTS OF THE INVENTION

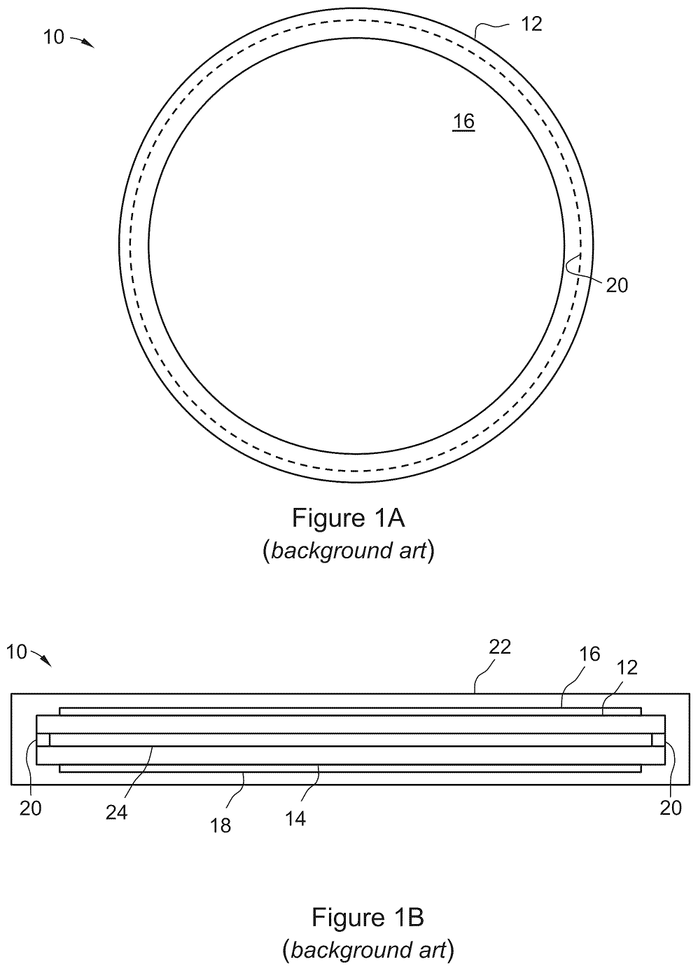

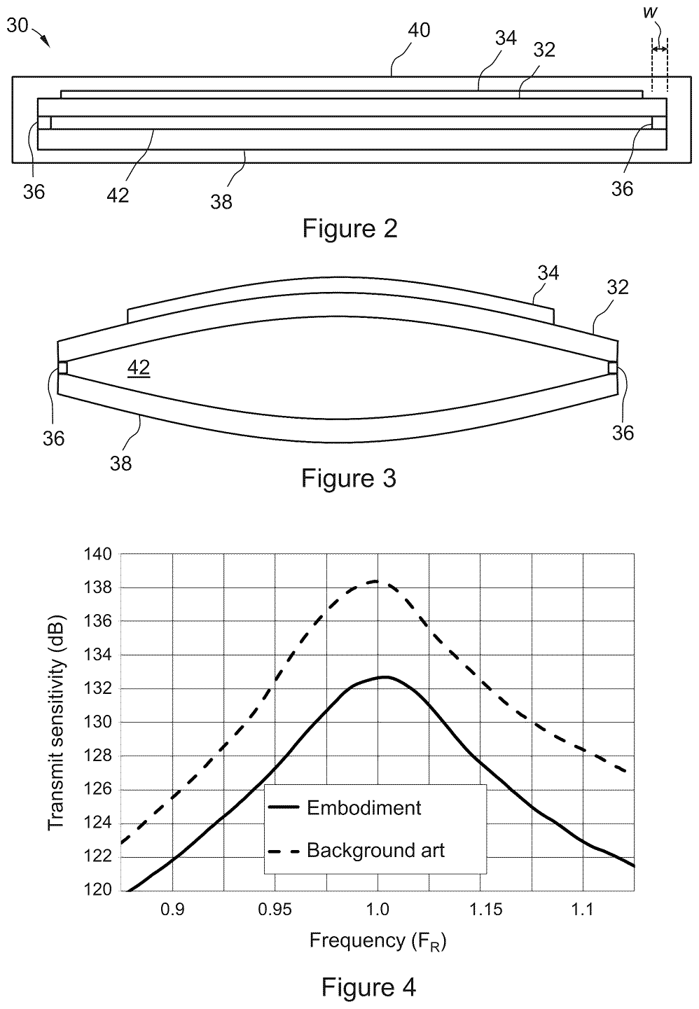

FIG. 2 is a schematic cross sectional view (comparable to that of FIG. 1B) of an acoustic transducer in the form of a piezoelectric bender 30. Bender 30 comprises an active assembly comprising a circular base plate 32 and a piezoelectric body 34 bonded to the base plate 32. In this embodiment, base plate 32 is metallic (e.g. of steel) or made of a ceramic (e.g. alumina).

Bender 30 includes an annular support structure 36 or ‘hinge’ to which base plate 32 is attached, and a passive vibrator 38 in the form of a plate, also supported by the base plate 32 but on the opposite side of the base plate 32 relative to the active assembly.

These components are encapsulated in a waterproof overmoulding 40. In this embodiment the encapsulant is a polyurethane, but in other embodiment, the encapsulant is made of rubber or another low modulus material.

Bender 30 is, in use, activated by a power supply (not shown) that is coupled to the piezoelectric body 34. Such a power supply is typically a high voltage power supply that includes an amplifier having voltage, current or output power feedback to control its output.

The active assembly 32, 34 and the passive vibrator 38 are constructed to have the same resonant frequency, and are mechanically coupled via the support structure 36. Hence, when the piezoelectric body 34 and active assembly 32, 34 is driven, the passive vibrator 38—owing to its being coupled to active assembly 32, 34—is actuated by the moment induced in the support structure 36 and vibrates at the same resonant frequency.

The base plate 32, support structure 36 and passive vibrator 38 define an internal cavity 42, which may be filled with air, some other gas, a liquid, or a liquid with compliant components.

The physical characteristics of the passive vibrator 38 (such as its density, thickness and modulus) are selected so that it has the same resonant frequency as the active assembly 32, 34. It may be desirable, in order to match the respective resonant frequencies, to model bender 30 (with, for example, FEA) to account for the complex boundary conditions. In this embodiment, passive vibrator 38 is made from metals such as steel or aluminium, or from a ceramic such as alumina. Other materials may alternatively be used, subject to being able to withstand the static pressure due to the depth of likely deployment.

The support structure 36 is shown in FIG. 2 as a separate component, but may be formed integrally with base plate 32 or passive vibrator 38. The support structure 36 has a width w that is minimised in order to reduce the rotational constraint that it imposes on base plate 32 or passive vibrator 38. The elastic limits of the material of the support structure 36 determines how thin the hinge can be made, again subject to expected static and dynamic loads. In this embodiment, support structure 36 is made of high tensile metals such as steel, or from a ceramic such as alumina. Other materials may alternatively be used, subject to being able sufficiently to withstand dynamic fatigue and static pressure due to the depth of likely deployment.

FIG. 3 is a schematic view of bender 30 in use (with waterproof overmoulding 40 omitted for clarity), with the active assembly 32, 34 and the passive vibrator 38 at maximum displacement from their equilibrium or undriven positions. Both are radiating into the surrounding medium.

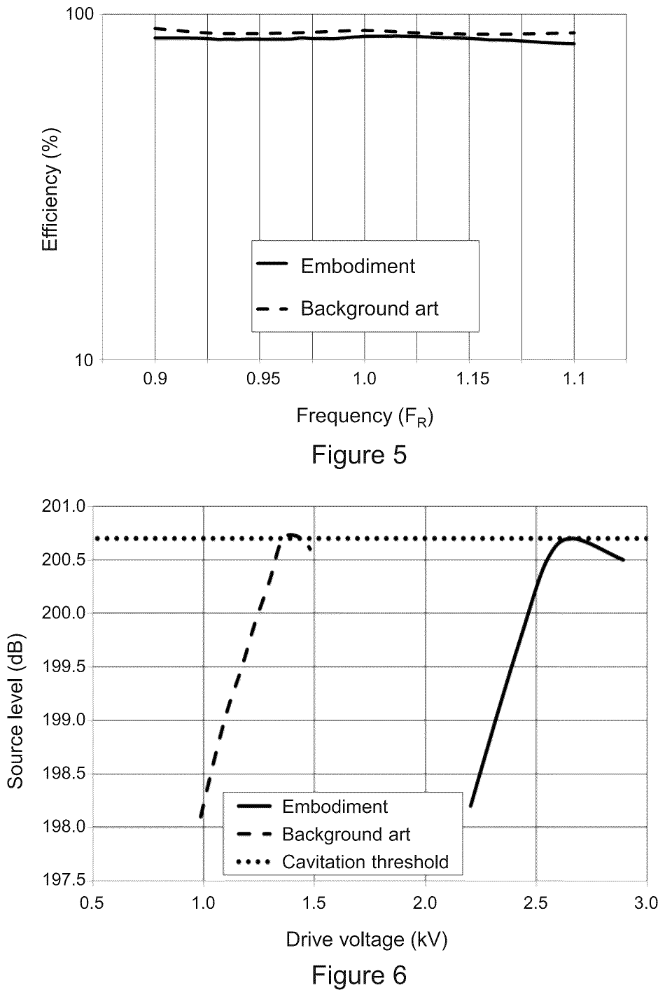

FIG. 4 is a plot of experimental results of measurements of transmit sensitivity (dB) versus frequency (relative to resonant frequency, FR), for both a background art bender (of the type shown in FIGS. 1A and 1B), shown with a dashed curve, and a bender according to this embodiment, shown with a solid curve. The plot shows, in effect, the output power as a function of frequency, for a fixed driving voltage. FIG. 5 is a plot of experimental results of measurements of efficiency (%) versus frequency (relative to resonant frequency, FR, 3 kHz in this example), also for both a background art bender (of the type shown in FIGS. 1A and 1B), shown with a dashed curve, and a bender according to this embodiment, shown with a solid curve.

It will be observed that the response of the bender according to this embodiment-measured as intensity—is approximately halved (that is, is 6 dB lower) compared with the background art bender, but that the efficiency of the bender according to this embodiment remains usefully high—and indeed is little diminished compared with the background art bender. It is also envisaged that refinement of the material of the passive vibrator 38, including by the use of low damping materials, should improve the efficiency of the bender according to this embodiment further. The transmit voltage response is reduced (compared with the background art bender) but, to provide equivalent performance, this drop can be compensated for by increasing the driving voltage by the same factor.

Careful design of bender 30 (and in particular of the passive vibrator 38) should allow the amplitude of the displacement of the passive vibrator 38 to be matched to that of the active assembly 32, 34. Radiation area is then maintained giving the same cavitation threshold as the equivalent background art bender. This is demonstrated by FIG. 6, which is a plot of experimental results of measurements of source level (dB) versus drive voltage (kV), for both a background art bender (of the type shown in FIGS. 1A and 1B), shown with a dashed curve, and a bender according to this embodiment, shown with a solid curve. The cavitation threshold is also plotted, shown with a dotted line, demonstrating that it closely matches that of the bender of the background art.

When compared with background art bender 10 of FIGS. 1A and 1B, passive vibrator 38 of bender 30 is thicker than base plate 14 thereby compensating for the stiffness otherwise contributed by omitted ceramic piezoelectric body 18. However, passive vibrator 38 is thinner than the total thickness of the active assembly (comprising base plate 14 and ceramic body 18), as the passive vibrator is generally much stiffer than the piezoceramic of ceramic piezoelectric body 18, allowing tighter packing and closer spacing of benders according to the present invention in a transducer array. It is envisaged that such a transducer array can exploit the phenomenon of the mutual coupling of the benders.

In addition, the overall mass of bender 30 may be reduced compared with the background art bender 10.

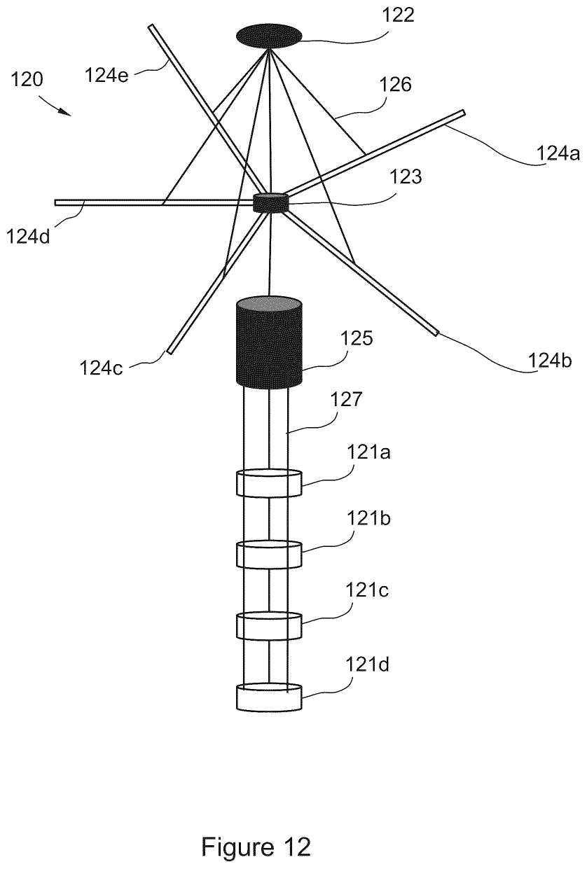

It is envisaged that embodiments of the piezoelectric transducers as described above are used in an array in a sonobuoy application. An embodiment substitutes transducers according to embodiments as described above in current state of the art type sonobuoys deployed from crewed vehicles aircraft, ships etc. It is envisaged that embodiments of the piezoelectric transducers as described above can also be utilised in sonobuoy embodiments for systems deployed from air, surface or underwater uncrewed systems. An example of a sonobuoy arrangement is shown (in a deployed position) in FIG. 12. The sonobuoy comprises a buoyant component 122 (for example a float) from which component of the sonobuoy are suspended in the water as the sonobuoy is deployed. An array of transducers 121a-d hang (for example by cords or light telescopic rods 127) below a cable unit 125, which in turn is suspended below a set of arms 124a-e from an array of arms carrying hydrophones (not shown) and control pack 123. The arms assembly (124a-e & 123), in turn, being suspended and deployed to an operational position by the lines 126 attached to the float 121. Prior to deployment the arms 124a-e are folded inward, toward the transducers 121a-d and other control units which are stacked to form a cylindrical shape, the whole assembly is housed in a cylindrical canister for handling and deployment. The tube can be launched from an aircraft or other vessel and as the tube enters the water vertically the float remains at the surface and the canister sinks releasing the components of the sonobuoy to assume the deployed configuration shown. The example of FIG. 12 shows an array of four transducers, however this could be more for less (for example 3-12 or more) with the limit to the number of transducers being due to canister size limitations, and how may can be fit into the canister, rather than a functional limitation. Increasing the number of transducers will typically improve the range of the sonobuoy.

Embodiments of the piezoelectric transducers described above can exhibit advantages that make these transducers particularly advantageous for sonobuoy applications. First, piezoelectric ceramic is typically heavy when compared to other materials used to construct the piezoelectric transducers, including the base plate and passive vibrator. By use of piezoelectric ceramic to drive only one base plate (that of the active assembly) and the passive vibrator being driven by mechanical connection to the driven base plate, the overall weight of the piezoelectric transducer is reduced compared to an embodiment employing two layers of piezoelectric ceramic, one on each side of the transducer. Such weight reduction can be of significant advantage in a sonobuoy array for reducing the overall weight of the sonobuoy. As sonobuoys are often deployed from aircraft, any reduction in weight may enable a greater number of sonobuoys to be carried for deployment, and/or reduce fuel required. Weight reduction can also be advantageous for safe handling by personnel loading the sonobuoys for deployment.

It should be appreciated that the bender configuration described above in relation to FIGS. 2 and 3 can reduce the overall weight of the bender due to omission of one piezoelectric layer.

Omission of one piezoelectric layer may also result in reductio in overall height of the encapsulated bender. Even a small (millimetre) size reduction can be significant when benders are packaged into a sonobuoy configuration. Sonobuoys typically have a common (standardized) package sizes, based on limitations/requirements of the equipment used to deploy the sonobuoys. This equipment is typically standardised, imposing a standardised canister size on sonobuoys for compatibility across suppliers. By reducing the size of the transducers, more transducers may be able to be packed into a sonobuoy array. Alternatively, instead of packing more transducers, the thinner transducers may release volume in the sonobuoy package that may be used to otherwise enhance the sonobuoy performance, such as enabling increase in power storage capacity (for example, increased battery size.) Otherwise, the released volume may be used for additional processing and memory resources or inclusion of other technologies, for example additional sensor packs (i.e. such as image or audible sensors).

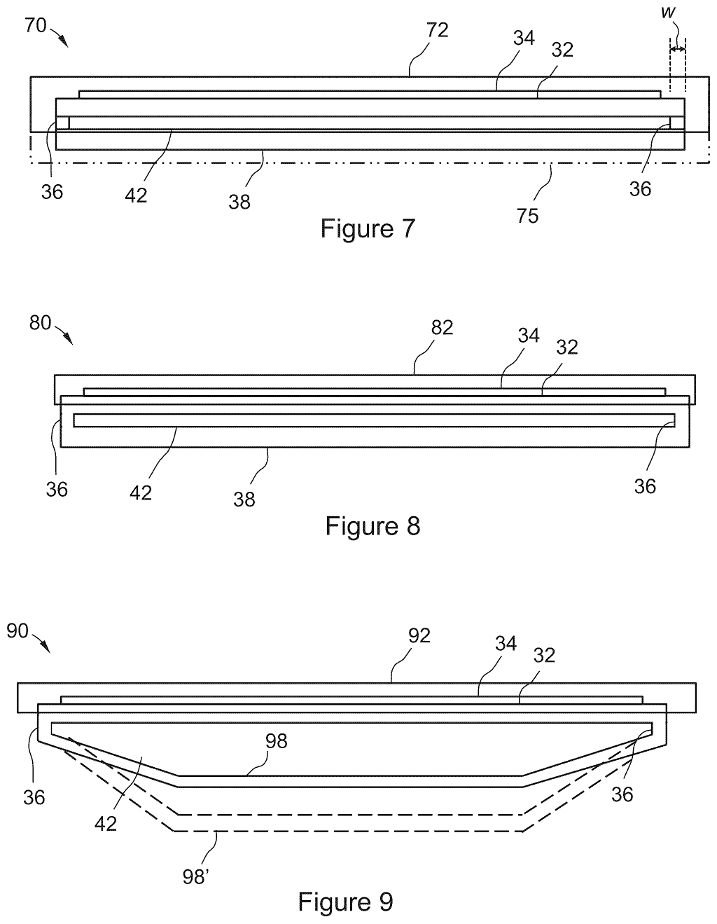

Transducers are typically wholly encapsulated by a flexible material. Encapsulation can protect the transducer from seawater or other environmental pollutants. One purpose for the encapsulation is protection of the piezoelectric ceramic. FIGS. 7 and 8 show examples of embodiments of the transducer as described above, which is only partially encapsulated. In these embodiments, the portion having the piezoelectric ceramic is encapsulated, while the passive vibrator is not.

FIG. 7 illustrates an example of partial encapsulation of an embodiment of a bender 70, similar to that described in relation to FIGS. 2 and 3. The bender 70 comprises an active assembly comprising a circular base plate 32 and a piezoelectric body 34 bonded to the base plate 32. The base plate 32 may be metallic (e.g. of steel) or made of a ceramic (e.g. alumina). Bender 70 includes an annular support structure 36 or ‘hinge’ to which base plate 32 is attached, and a passive vibrator 38 in the form of a plate, also supported by the base plate 32 but on the opposite side of the base plate 32 relative to the active assembly. In the embodiment the active assembly and hinge 36 are encapsulated in a waterproof overmoulding 72, however this does not extend over the passive vibrator 38. For comparison the dotted line 75 illustrates the overmoulding of FIG. 2. It should be apparent from FIG. 7 that reduction of the encapsulation to only partial encapsulation can reduce the overall heights of the bender by at least a few millimetres. Even a few millimetre height reduction can result in a significant saving in packing size of the sonobuoy transducer array having a plurality of these transducers. In this embodiment the encapsulant is a polyurethane, but in other embodiment, the encapsulant is made of rubber or another low modulus material.

In FIG. 7 the overmoulding is shown extending beyond the outer periphery of the active assembly base plate 32. This extending edge may include apertures for rods or cords connecting the transducers into a sonobuoy array configuration. For example, telescoping rods may be connected into the overmoulding, these rods being configured to hold the transducers at a predetermined distance apart when extended into the deployed position. In another embodiment, the overmoulding may include apertures through which cord may be threaded. The cord can be knotted, clamped, glued or otherwise secured to or proximate each transducer to maintain a specified distance between the transducers when deployed. In the undeployed state, the cord can coil in the space below the overmoulding beside the transducer.

FIG. 8 shown another example of partial encapsulation of the bender 80. In this embodiment the encapsulate 82 does not extend over the hinge 36. In an embodiment the encapsulant 82 may also not extend past the ends of the base plate 32, provide the piezoelectric ceramic 34 is encapsulated. The reduction in amount of encapsulating material can further reduce the weight of the transducer 80 in addition to reducing the height.

This bender configuration reduces the overall height of the encapsulated bender and an array of said benders. In the envisaged application where the array will be packaged in a size A Sonobuoy canister for deployment from generic launch systems. This releases volume that could be used to enhance the Sonobuoy performance such as greater source level, longer life of the inclusion of other technologies.

In embodiments discussed above, the passive vibrator is described as having the same resonant frequency as the piezoelectric bender. However, in alternative embodiments the passive radiator could be set to resonate at another frequency which may widen the bandwidth of the transducer. This may be achieved by altering thickness, shape, or composition of the passive vibrator. Such adjustment of the passive vibrator may widen the bandwidth of the transducer. The passive vibrator is activated similarly to described above, by mechanical coupling of vibrations from the active assembly via the hinge 36, however by virtue of the size, shape, and/or composition the passive vibrator is tuned to vibrate at a different frequency.

In an embodiment the passive vibrator is of the same size and shape as the base plate but of a different thickness, tuned to vibrate and a harmonic of the active assembly resonant frequency.

In another embodiment the radiating face resonance may be at half the resonant frequency as the piezoelectric bender and the energy coupled by the hinge would excite the passive radiator parametrically. This would create a dual frequency transmission with one frequency being half of the original frequency.

Another embodiment is to have a passive radiator operating at an alternate frequency either modifying the bandwidth of the whole transducer or operating at a separate frequency.

It should be noted that conventional benders, as show in the prior art of FIG. 1A and 1B, require both base plates to be flat due to the use of flat piezoelectric ceramic (16, 18) as the driving elements. In embodiments of the present invention the passive radiator (38) is no longer restricted to being flat. As the passive vibrator is driven by the mechanical coupling from the active assembly the shape of the radiating face can be modified. The radiator could be domed or have other configuration which provides a mechanical amplification. For example, embodiments may be based on shapes of Class V flextensional transducers. Using a domed or frustoconical shape may induce a higher volume displacement on the passive vibrator side of the bender to that of the active assembly. In some embodiments this can improve the sensitivity of the bender. The different shape can compensate for the sensitivity loss, illustrated in FIG. 4, by removal of the second piezoelectric drive element. By utilising a shape which will result in higher volume displacement (compared with a flat passive vibrator) it may be possible to recover some of or exceed that lost by the removal of the second piezoelectric element.

FIG. 9 shows an example of an embodiment of a bender 90 with a passive vibrator shaped based on flextensional principles. In this embodiment the active assembly comprising a base plate 32 and piezoelectric bender 34 are similar to other embodiments described above, in this example the base plate 32 is round or elliptical. The passive vibrator 98 in this embodiment is a shell having a frustoconical or cymbal shape. As the hinge 36 moves inward (radially) as the active assembly is driven to bend, the shape of the passive vibrator translates this into greater vertical (axial) movement of the passive vibrator 98′. Flexing of the passive vibrator will displace more volume than that of the active assembly by virtue of greater surface area. The angled shape of the passive vibrator can also increase the maximum vertical (axial) movement of the shell relative to that of the active assembly. The shape of the shell 98 may also contribute to tuning of the passive vibrator resonant frequency. In the embodiment of FIG. 9 the bender 90 is shown having only partial encapsulation 92, however embodiments having increased partial or complete encapsulation are also envisaged.

It should be appreciated that although the shape of the passive vibrator of this embodiment increases the resting height of the bender 90, this increase in height can be compensated by use of partial encapsulation. Thus, in an embodiment the bender 90 may match the height of a prior art bender for sonobuoy applications.

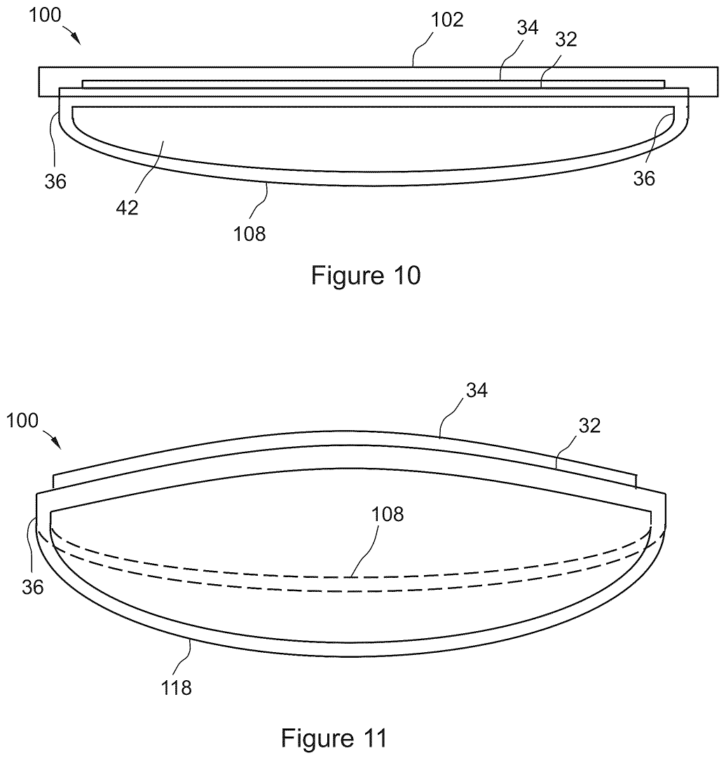

FIGS. 10 and 11 schematically illustrate an alternative embodiment of a bender 100 having a domed passive vibrator 108. Similar to the embodiment described above in relation to FIG. 9, this embodiment employs flextensional transducer principles. As shown in FIG. 11, as the active assembly comprising the base plate 32 and piezoelectric ceramic 34 flex, the passive vibrator is also driven to flex between its resting 108 and displaced position 118. The passive vibrator 108 may be tuned to vibrate at the same resonant frequency as the active assembly or a different frequency.

It should be appreciated that the passive vibrator may have a polygonal or polyhedral flextensional shape, in particular for embodiments where the external periphery of the bender is not round or oval, for example square, rectangular, hexagonal or otherwise polygonal, the passive vibrator may have a suitably polyhedral flextensional shape.

It will be understood to persons skilled in the art of the invention that many modifications may be made without departing from the spirit and scope of the invention.

In the claims that follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that such prior art forms a part of the common general knowledge in the art, in any country.

1. An acoustic transducer, comprising:
a support structure;
an active assembly comprising a base plate supported by the support structure and a piezoelectric body supported by the base plate; and
a passive vibrator supported by the support structure and mechanically coupled via the support structure to the active assembly so that bending vibration of the active assembly drives the passive vibrator to also bend and thereby vibrate, and
wherein the passive vibrator is configured to vibrate at a predetermined resonant frequency.

2. An acoustic transducer as claimed in claim 1, wherein the piezoelectric body is a piezoelectric ceramic body.

3. An acoustic transducer as claimed in claim 1, wherein passive vibrator is configured by any one or more of shape, thickness and material composition to resonate at the predetermined resonant frequency, and wherein the predetermined frequency is different to the resonant frequency of the active assembly.

4. An acoustic transducer as claimed in claim 3, wherein the passive vibrator comprises a plate, of a thickness configured to vibrate at the predetermined frequency, and wherein the predetermined frequency is half the resonant frequency of the active assembly.

5. An acoustic transducer as claimed in claim 3, wherein the passive vibrator comprises a plate, of a thickness configured to vibrate at the predetermined frequency, and wherein the predetermined frequency is a harmonic of the resonant frequency of the active assembly.

6. An acoustic transducer as claimed in claim 1, wherein the passive vibrator comprises has a flextesional transducer shape.

7. An acoustic transducer as claimed in claim 6, wherein the passive vibrator comprises has any one of a domed, frustoconical, cymbal, or polyhedral flextesional shape.

8. An acoustic transducer as claimed in claim 6, wherein the passive vibrator is configured by any one or more of the flextensional shape, thickness and material composition to resonate at the predetermined resonant frequency, and wherein the predetermined frequency is different to the resonant frequency of the active assembly.

9. An acoustic transducer as claimed in claim 1, further comprising a flexible encapsulating covering over the active assembly.

10. An acoustic transducer as claimed in claim 9, wherein the flexible encapsulating covering does not extend over the passive vibrator.

11. An acoustic transducer as claimed in claim 1, wherein the transducer is circular.

12. An acoustic transducer as claimed in claim 1, wherein the transducer is elliptical, rectangular, or polygonal.

13. An acoustic transducer as claimed in claim 1, wherein a cavity defined by the active assembly, the vibrator and the support structure is filled with a fluid.

14. An acoustic transducer as claimed in claim 1, wherein the support structure is integral with the base plate and/or the passive vibrator.

15. A sonobuoy transducer array, comprising:
a plurality of acoustic transducers as claimed in claim 1;
wherein the plurality of acoustic transducers are connected together to move between a proximal packed configuration and a spaced apart deployed configuration.

16. A sonobuoy transducer array, comprising:
a plurality of acoustic transducers as claimed in claim 3;
wherein the plurality of acoustic transducers are connected together to move between a proximal packed configuration and a spaced apart deployed configuration.

17. A sonobuoy transducer array, comprising:
a plurality of acoustic transducers as claimed in claim 4;
wherein the plurality of acoustic transducers are connected together to move between a proximal packed configuration and a spaced apart deployed configuration.

18. A sonobuoy transducer array, comprising:
a plurality of acoustic transducers as claimed in claim 6;
wherein the plurality of acoustic transducers are connected together to move between a proximal packed configuration and a spaced apart deployed configuration.

19. A sonobuoy transducer array, comprising:
a plurality of acoustic transducers as claimed in claim 8;
wherein the plurality of acoustic transducers are connected together to move between a proximal packed configuration and a spaced apart deployed configuration.

20. A sonobuoy transducer array, comprising:
a plurality of acoustic transducers as claimed in claim 10;
wherein the plurality of acoustic transducers are connected together to move between a proximal packed configuration and a spaced apart deployed configuration.
